(19) United States
(12) Patent Application Publication
(10) Pub. No.: US 2015/0265991 A1
(43) Pub. Date: Sep. 24, 2015

(54) MIXTURE OF ISOCYANATE COMPOUNDS AND ITS USE AS EMULSIFIER

(71) Applicants: ROHM AND HAAS COMPANY, Philadelphia, PA (US); DOW GLOBAL TECHNOLOGIES LLC, Midland, MI (US)

(72) Inventors: Yongchun CHEN, Shanghai (CN); Shiling ZHANG, Shanghai (CN); Guoling HOU, Shanghai (CN); Mai CHEN, Chicago, IL (US)

(21) Appl. No.: 14/437,207

(22) PCT Filed: Oct. 28, 2013
(86) PCT No.: PCT/CN13/86027

§ 371 Date: Apr. 21, 2015

(30) Foreign Application Priority Data
Oct. 29, 2012 (CN) 201210421446.2

(51) Int. Cl. B01F 17/00

(52) U.S. Cl. CPC B01F 17/0092

(57) ABSTRACT

Provided is a composition comprising (a1) one or more compound that is a trimer of a diisocyanate that has structure A1-NCO; (b1) one or more compound having the structure A1-L1-(CH₂CH₂O)ₙ—Z; (a2) one or more compound that is a trimer of a diisocyanate that has structure A2-NCO; and (b2) one or more compound having the structure A2-L2-Q-G; wherein A1 in structure II-1 is identical to A1 in structure I-1, L1 is a linking group formed by a reaction of an isocyanate group with an isocyanate-reactive group, n is 5 to 25, Z is an alkyl group, A2 in structure II-2 is identical to A2 in structure I-2, L2 is a linking group formed by a reaction of an isocyanate group with an isocyanate-reactive group, Q is an organic group, G is an anionic group, A1 and A2 may be identical or different, wherein wa1+wa2 is 0% to 90%, wherein wa1 is the weight percent of said compound (a1), based on the total solids weight of said composition, wherein wa2 is the weight percent of said compound (a2), based on the total solids weight of said composition, wherein wb1+wb2 is 10% to 100%, wherein wb1 is the weight percent of said compound (b1), based on the total solids weight of said composition, wherein wb2 is the weight percent of said compound (b2), based on the total solids weight of said composition, and wherein the ratio wb1:wb2 is between 0.01:1 and 100:1.

Also provided is an emulsion comprising particles suspended in an aqueous medium, wherein the particles comprise said composition and further comprise (c) one or more water-insoluble compound that is different from said trimer (a).

It is often desirable to provide a water-insoluble compound in a waterborne composition. One possible approach to this goal is to attempt to form an emulsion of droplets in water, where the droplets contain the water-insoluble compound and where those droplets are stabilized by an emulsifier. In such an emulsion, it is sometimes also desirable that the emulsifier is capable of acting as a crosslinker.

U.S. Pat. No. 6,767,958 describes reacting a polyisocyanate with 2-(cyclohexylamino)-ethanesulfonic acid and/or 3-(cyclohexylamino)-propanesulfonic acid and optionally also with a monohydric polyalkylene oxide polyether alcohol.

It is desired to provide a compound that has two or more isocyanate groups and that is capable of acting as an emulsifier for stabilizing emulsions of water-insoluble compounds. Also desired are emulsions made of such water-insoluble compounds and such emulsifiers. It is further desired to provide a compound that has two or more isocyanate groups and that is capable of acting as an emulsifier for stabilizing emulsions of water-insoluble aromatic polyisocyanates. Also desired are emulsions made of such aromatic polyisocyanates and such emulsifiers.

The following is a statement of the invention.

The first aspect of the present invention is a composition comprising

(a1) one or more compound that is a trimer of a diisocyanate that has structure I-1:

A1-NCO I-1

(b1) one or more compound having the structure II-1:

A1-L1-(CH₂CH₂O)ₙ—Z II-1

(a2) one or more compound that is a trimer of a diisocyanate that has structure I-2:

A2-NCO I-2

and

(b2) one or more compound having the structure II-2:

A2-L2-Q-G II-2

wherein
A1 in structure II-1 is identical to A1 in structure I-1,
L1 is a linking group formed by a reaction of an isocyanate group with an isocyanate-reactive group,
n is 5 to 25,
Z is an alkyl group,
A2 in structure II-2 is identical to A2 in structure I-2,
L2 is a linking group formed by a reaction of an isocyanate group with an isocyanate-reactive group,
Q is an organic group, and
G is an anionic group,
A1 and A2 may be identical or different,

wherein
wa1+wa2 is 0% to 90%,
wherein wa1 is the weight percent of said compound (a1), based on the total solids weight of said composition,
wherein wa2 is the weight percent of said compound (a2), based on the total solids weight of said composition,

wherein
wb1+wb2 is 10% to 100%,
wherein wb1 is the weight percent of said compound (b1), based on the total solids weight of said composition,
wherein wb2 is the weight percent of said compound (b2), based on the total solids weight of said composition,

and wherein the ratio wb1:wb2 is between 0.01:1 and 100:1.

The second aspect of the present invention is an emulsion comprising particles suspended in an aqueous medium, wherein said particles comprise the composition of the first aspect of the present invention and further comprising (c) one or more water-insoluble compound that is different from said trimer (a).

The following is a detailed description of the invention.

As used herein, the following terms have the designated definitions, unless the context clearly indicates otherwise.

The isocyanate group is —NCO. A polyisocyanate is a compound having two or more isocyanate groups. Some polyisocyanates are polymers and some are not. A diisocyanate is a compound that has exactly two isocyanate groups. The structure of a diiosocyanate is OCN—R—NCO, where R is any organic group, which may be substituted or unsubstituted. If R is aliphatic, the diisocyanate is an aliphatic diisocyanate. If R contains any aromatic ring, the diisocyanate is an aromatic diisocyanate.

A trimer of a diisocyanate has the structure III:

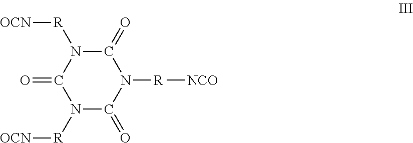

Because structure III is the trimer of a diisocyanate, the R groups in structure III are identical to each other.

As used herein, a “residue” of a trimer of a diisocyanate is what remains of structure III when a single isocyanate group is disregarded. Structure III may be re-drawn to have the structure A-NCO, where A is the residue of the trimer of a diisocyanate. A has two isocyanate groups.

As used herein, an isocyanate-reactive group is a group that is capable of reacting with an isocyanate group. A linking group is the group formed when an isocyanate group reacts with an isocyanate-reactive group. For example, when an isocyanate group reacts with a hydroxyl group or with an amine group, the resulting linking group is a urethane group or a urea group, respectively. The urethane group has structure IV-1:

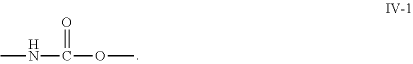

The urea group has structure IV-2:

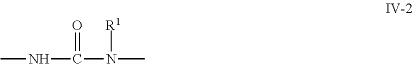

where R¹ is an organic group.

As used herein, an anionic group is a chemical group that carries negative charge. The negative charge may be −1, −2, or −3. A compound with an anionic group is associated with one or more cation. The associated cation may be a metal cation or an organic compound with a cationic group (i.e., a group have a positive charge of +1, +2, or +3). When a compound with an anionic group is in solid form or is in a nonpolar environment, the associated cation(s) is located adjacent to the anionic group. When such a compound is dissolved or dispersed in water, the anionic group and the associated cation(s) may be separated.

As used herein, an epoxy compound is a compound having one or more epoxy group. A polyepoxy compound is a compound having two or more epoxy groups. A polyepoxy compound may or may not be a polymer.

As used herein a crosslinker is a compound that has two or more reactive groups and that is capable of reacting with reactive groups attached to polymer chains to form crosslinks between polymer chains. The reactive groups on the crosslinker may be the same as or different from the reactive groups attached to the polymer chains.

An aqueous medium is a continuous medium that contains 50% or more water by weight based on the weight of the continuous medium. As used herein, an emulsion is a dispersion of particles distributed through an aqueous medium. The particles in an emulsion may have weight-average particle diameter of 10 nm to 10 micrometer. Weight-average particle diameter herein is known as D50.

A compound is considered herein to be water-insoluble if the maximum amount of that compound that can dissolve in 100 g of water at 25° C. is 0.5 grams.

A composition herein may be characterized by its “total solids weight.” The total solids weight is the sum of the weights of all of the non-volatile compounds in the composition. The total solids weight is determined as follows. A sample of known initial weight of the composition is placed in an oven at 100° C. and 1 atmosphere pressure, with circulating air or other conditions that allow volatile compounds in the sample, if any, to evaporate. The sample remains in the oven until its weight does not change appreciably as a function of time. The weight of the sample after this heating process is the total solids weight.

As used herein, the statement that a ratio is X:1 or higher means that the ratio is Y:1, where Y is equal to or greater than X. Similarly, the statement that a ratio is Z:1 or lower means that the ratio is W:1, where W is equal to or less than Z.

The present invention involves a trimer of a diisocyanate (herein called “trimer (a1)”) having structure III. Trimer (a1) has the structure I-1:

A1-NCO I-1

Residue A1- has the structure V:

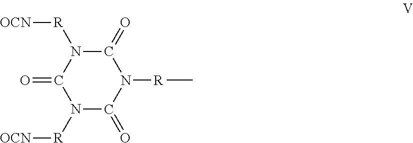

The diisocyanate of which trimer (a1) is the trimer is known herein as “diisocyanate (a1).” Preferably, diisocyanate (a1) is an aliphatic diisocyanate. More preferably, diisocyanate (a1) is 1,6 hexamethylene diisocyanate (HDI), 1-isocyanato-3-isocyanatomethyl-3,5,5-trimethyl-cyclohexane (IPDI), 4,4′-diisocyanato dicyclohexylmethane (H₁₂MDI), or di-isocyanatomethyl-cyclohexane (ADI). More preferably, diisocyanate (a1) is HDI or ADI.

The present invention also involves a compound (herein called “compound (b1)”) having structure II-1:

A1-L1-(CH₂CH₂O)ₙ—Z II-1

where A1 in structure II-1 is identical to A1 in structure I-1; L1 is a linking group formed by a reaction of an isocyanate group with an isocyanate-reactive group, n is 5 to 25, and Z is an alkyl group. Z may be linear, branched, cyclic, or a combination thereof.

Preferably, L1 is a urea group or a urethane group. More preferably, L1 is a urethane group. Preferably, n is 7 or more; more preferably 10 or more. Preferably, n is 18 or less; more preferably 14 or less. Preferably, Z is a linear or branched alkyl group having 1-8 carbon atoms; more preferably Z is a linear or branched alkyl group having 1-4 carbon atoms; more preferably Z is methyl.

The present invention involves a trimer of a diisocyanate (herein called “trimer (a2)”) having structure III. Trimer (a2) has the structure I-2:

A2-NCO I-2

Residue A2- has the structure V as defined herein above.

The diisocyanate of which trimer (a2) is the trimer is known herein as “diisocyanate (a2).” Diisocyanate (a2) may be the same as or different from diisocyanate a1. The preferred compounds for diisocyanate (a2) are the same as those described herein above for diisocyanate a1.

The present invention also involves a compound (herein called “compound (b2)”) having structure II-2:

A2-L2-Q-G II-2

where A2 in structure II-2 is identical to A2 in structure I-2; L2 is a linking group formed by a reaction of an isocyanate group with an isocyanate-reactive group, Q is an organic group, and R is an anionic group.

Preferably, L2 is a urea group or a urethane group. More preferably, L2 is a urea group having structure IV-2. More preferably L2 is a urea group having structure IV-2 in which R¹ is an unsubstituted alkyl group; more preferably R¹ is an alkyl group having 4 to 8 carbon atoms; more preferably R¹ is cyclohexyl.

Preferably, Q is an alkyl group that is linear, branched, cyclic, or a combination thereof. More preferably, Q is a linear alkyl group. More preferably, Q is —(CH₂)ₙ— where n is 1 to 8. More preferably, Q is —(CH₂)ₙ— where n is 3.

Preferably, G is sulfonate or carboxylate. More preferably G is sulfonate.

The composition of the present invention may be characterized by the amounts of the various ingredients. The following abbreviations are used:
wa1=the weight percent of compound (a1), based on the total solids weight of the composition,
wa2=the weight percent of compound (a2), based on the total solids weight of the composition,
wb1=the weight percent of compound (b1), based on the total solids weight of the composition,
wb2=the weight percent of compound (b2), based on the total solids weight of the composition.

Preferably, wa1+wa2 (i.e., the sum of wa1 plus wa2) is 10% or more; more preferably 20% or more; more preferably 30% or more. Preferably, wa1+wa2 is 80% or less; more preferably 70% or less.

Preferably, the ratio of wb1:wb2 is 4:1 or less; more preferably 2.3:1 or less; more preferably 1.5:1 or less. Preferably the ratio of wb1:wb2 is 0.25:1 or more; more preferably 0.43:1 or more; more preferably 0.67:1 or more.

Preferably, wb1+wb2 (i.e., the sum of wa1 plus wa2) is 20% or more; more preferably 30% or more. Preferably, wb1+wb2 is 90% or less; more preferably 80% or less; more preferably 70% or less.

A preferred method (herein called the “double mixture” method) of making the composition of the present invention includes the steps of making a mixture (1), making a mixture (2), and then making a composition that contains both mixture (1) and mixture (2). Mixture (1) contains trimer (a1) and compound (b1). In mixture (1), the ratio of the sum of the moles of isocyanate groups on trimer (a1) plus the moles of L1 groups to the moles of Z groups is 5:1 to 20:1. Mixture (2) contains trimer (a2) and compound (b2). In mixture (2), the ratio of the sum of the moles of isocyanate groups on trimer (a2) plus the moles of L2 groups to the moles of Q groups is 6:1 to 14:1.

Among embodiments using the double mixture method, the preferred weight ratio of mixture (1) to mixture (2) is 0.1:1 or higher; more preferably 0.5:1 or higher; more preferably 0.8 or higher. Among embodiments using the double mixture method, the preferred weight ratio of mixture (1) to mixture (2) is 10:1 or lower; more preferably 5:1 or lower; more preferably 2:1 or lower; more preferably 1.2:1 or lower.

Some aspects of the present invention involve an emulsion that contains particles suspended in an aqueous medium. The particles contain trimer (a), compound (b), and an additional compound (herein called “compound (c)”). Compound (c) is water-insoluble and is different from all of trimer (a1), trimer (a2), compound (b1), and compound (b2).

While the present invention is not limited to any specific mechanism, it is contemplated that some or all of compound (c), some or all of trimer (a1), and some or all of trimer (a2) form a mixture in the interior of each particle and that some or all of compounds (b1) and (b2) reside at the interface between the particle and the aqueous medium. It is contemplated that some or all of compound (c) acts as emulsifier to form and stabilize the particles.

Preferably, compound (c) is a crosslinker. More preferably, compound (c) is a polyepoxy compound or a polyisocyanate. More preferably, compound (c) is a polyisocyanate. Preferred aliphatic polyisocyanates are HDI, IPDI, H₁₂MDI, ADI, isomers thereof, polymers thereof, and mixtures thereof. Compound (c) preferably is an aromatic polyisocyanate. Preferred aromatic polyisocyanates are toluylene-2,4-diisocyanate (2,4-TDI), toluylene-2,6-diisocyanate (2,6-TDI), naphthylene-1,5-diisocyanate, diphenylmethane-4,4′-diisocyanate (MDI), isomers thereof, polymers thereof, and mixtures thereof. More preferred are 4,4′-MDI; 2,4′-MDI, polymers thereof, and mixtures thereof.

Preferably the D50 of the particles is 10 nm or larger; more preferably 50 nm or larger. Preferably, the particles have D50 of 2,000 nm or smaller; more preferably 1,000 nm or smaller; more preferably 500 nm or smaller.

Preferably, the emulsion is stable. A stable emulsion does not show any phase separation, settling, floatation, or aggregation upon storage at 25° C. Preferably, the emulsion is stable for 2 hours or more; more preferably 5 hours or more; more preferably 10 hours or more.

It is sometimes useful, prior to making the emulsion that contains compound (c), to make the mixture of trimers (a1) and (a2) and compounds (b1) and (b2) as described in the first aspect of the present invention, without including any compound (c). When a composition containing 4 parts by weight of such a mixture and 96 parts by weight of water, at 25° C., particles suspended in an aqueous medium will form, and preferably the D50 of the particles is 10 nm or larger. Preferably, such particles will have D50 of 1,000 nm or smaller; more preferably 500 nm or smaller; more preferably 300 nm or smaller.

The following are examples of the present invention.

Unless otherwise stated, all operations were performed at ambient temperature, approximately 23° C. “nt” means not tested. Polymeric MDI (“PMDI”) was PAPI™ 135 polymeric MDI, from The Dow Chemical Company.

The emulsion particle sizes (“PS”) were measured by 90Plus™ particle size analyzer (Brookhaven Instruments).

The percent remaining NCO (“% Rem”) was measured as follows. First, “% NCO” was measured using a titration method. A sample containing isocyanate groups was reacted with a molar excess of dibutylamine (DBA) in a solution of toluene and dimethyl formamide; the excess DBA was titrated to neutrality with a hydrochloric acid (HCl) solution; from the weight of the sample and the amounts of DBA and HCl used, % NCO is calculated as follows:

% NCO=100*42.02*(equivalents of DBA consumed)/(weight of sample)

For a given sample, % NCO was measured as a function of time, and % REM was calculated as follows:

% REM=100*(% NCO after elapsed time)/(initial % NCO)

Viscosity was measured at 25° C. using a Brookfield CAP2000+™ viscometer from Brookfield Engineering. Results are reported in units of mPa*s, which is numerically equal to units of centipoise.

### EXAMPLE 1

### Ethoxylated HDI Trimer without Compound (c)

HDI trimer has structure III where —R— is —(CH₂)₆—. Carboxax™ MPEG 550 polymer (The Dow Chemical Company) has the structure CH₃—(OCH₂CH₂)ₙ—OH, where n has the average value of 11.8. HDI trimer was mixed with Carbowax™ MPEG 550 polymer to form a reaction mixture. The reaction mixture, prior to the reaction taking place, had ratio of moles of isocyanate groups to moles of hydroxyl groups of 6:1. The reaction mixture was held at 100° C. for five hours. It is contemplated that the reaction product included a compound having structure

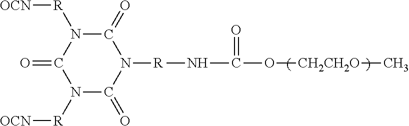

where R is —(CH₂)₆— and n has average value of 11.8.

### EXAMPLE 2

### Anionic HDI Trimer without Compound (c)

A reaction mixture was formed by mixing HDI, 3-(cyclohexylamino)-1-propanesulfonic acid (“CAPS”), and N,N-dimethylcyclohexylamine (“DMCHA”). The mole ratio of CAPS to DMCHA was 1:1. The mole ratio of NCO:NH was 7:1. The reaction mixture was heated at 80° C. for 3 hours. The reaction product contained a compound having the following structure:

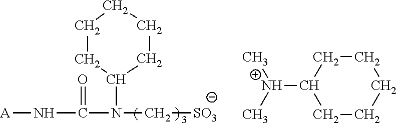

where A is the residue of HDI trimer.

### EXAMPLE 3

### Various Weight Ratios

Mixtures were made of the reaction product from Example 1, the reaction product from Example 2, and water. There were 96 parts by weight water, and 4 parts by weight of the sum of Example 1 and Example 2. The weight ratio of Example 1 to Example 2 was varied. The amount of NCO groups was measured as a percentage of the initial amount of NCO groups for each mixture. The results were as follows:

Percent of NCO Groups (% Rem) as a Function of Time

| | Weight Ratio of (Example 1):(Example 2) | | | | | |
|---|---|---|---|---|---|---|
| Time (hr) | 0.25:1 | 0.5:1 | 1:1 | 2:1 | 4:1 | 8:1 |
| 0 | 100 | 100 | 100 | 100 | 100 | 100 |
| 1 | 60 | 60 | 70 | 60 | 60 | 60 |
| 2 | 50 | 50 | 60 | 50 | 50 | 50 |
| 3 | 42 | 42 | 55 | 42 | 42 | 42 |
| 5 | 41 | 41 | 50 | 41 | 41 | 41 |
| 8 | 37 | 37 | 45 | 37 | 37 | 37 |

All the samples maintained an acceptable amount of NCO groups. The sample with weight ratio of 1:1 was better than the others.

### EXAMPLE 4

### Blends with Liquid Epoxy

Blends were made of water, emulsifier, and epoxy (D.E.R.™ 331™ liquid epoxy resin, from The Dow Chemical Company). The emulsifier was either Example 1, Example 2, or “Hybrid” (i.e., a mixture of Example 1 with Example 2 with 1:1 weight ratio). The amount of epoxy plus the amount of emulsifier was 4 parts by weight. The amount water was 96 parts by weight. The results were as follows. “nt” means not tested.

Emulsion Average Particle Size (nm)

| Epoxy to Emulsifier | | | |
|---|---|---|---|
| weight ratio | Example 1 | Example 2 | Hybrid |
| 0.25:1 | 125 | 83 | nt |
| 0.5:1 | nt | 950 | 94 |
| 0.75:1 | 145 | nt | nt |
| 1:1 | 266 | agglomerate | 105 |
| 1.5:1 | 1186 | agglomerate | 164 |
| 2:1 | nt | nt | 1075 |

The hybrid emulsifier produced smaller particle emulsions. Also, the hybrid emulsifier was able to produce acceptable emulsions (i.e., particle size below 1,000 nm) at higher levels of epoxy.

### EXAMPLE 5

### Blends with Other Epoxies

Emulsions were made as in Example 4 except for the use of different epoxy compounds. Particle size of the emulsion (“PS”) was measured immediately after making the emulsion (“init”) and after one month storage (“month”). The epoxies used were as follows. All are supplied by the Dow Chemical Company.

“736” is D.E.R.™ 736™ liquid epoxy

“330” is D.E.R.™ 330™ liquid epoxy

“852” is D.E.R.™ 852™ liquid epoxy

“671” is D.E.R.™ 671™ liquid epoxy

The results were as follows:

| Epoxy Type | Weight ratio⁽¹⁾ | init. PS (nm) | month PS (nm) |
|---|---|---|---|
| 736 | 1:1 | 75 | 37 |
| 330 | 1:1 | 192 | 210 |
| 852 | 1:1 | 252 | 42 |
| 671 | 0.43:1 | note (2) | nt |
| 671 | 0.67:1 | note (2) | nt |
| 671 | 1:1 | note (2) | nt |

Note⁽¹⁾:
weight ratio of epoxy to emulsifier
Note (2):
acceptable emulsion with good visual appearance

All the samples showed acceptable emulsions.

### EXAMPLE 6

### Blends with Polymeric MDI

Blends were made of water, emulsifier, and polymeric MDI (“PMDI”). The emulsifier was either Example 1, Example 2, or “Hybrid” (i.e., a mixture of Example 1 with Example 2 with 1:1 weight ratio). The emulsion particle sizes were measured as in Example 4. The amount of PMDI plus the amount of emulsifier was 4 parts by weight. The amount water was 96 parts by weight. The results were as follows.

Emulsion Average Particle Size (nm)

| PMDI to Emulsifier | | | |
|---|---|---|---|
| weight ratio | Example 1 | Example 2 | Hybrid |
| 0.25:1 | 53 | 51 | 33 |
| 0.5:1 | 105 | 62 | 48 |
| 0.75:1 | 123 | agglomerate | 115 |
| 1:1 | agglomerate | agglomerate | 134 |
| 1.5:1 | agglomerate | agglomerate | agglomerate |

The hybrid emulsifier produced smaller particle emulsions. Also, the hybrid emulsifier was able to produce acceptable emulsions (i.e., without agglomeration) at higher levels of PMDI.

### EXAMPLE 7

### Duration of Isocyanate Activity

The emulsifier was a mixture of Example 1 with Example 1 at weight ratio 1:1. Blends were made with water, emulsifier, HDI trimer, and MDI. The amount of MDI plus the amount of emulsifier plus the amount of HDI trimer was 4 parts by weight. The amount water was 96 parts by weight. The MDI was either MDI monomer or PMDI.

The amount of NCO groups was measured as a percentage of the initial amount of NCO groups for each mixture. The remaining NCO (% Rem) was reported after 8 hours of ambient storage (“NCO-8 hr”). Results were as follows:

| MDI | Weight ratio | viscosity | PS | NCO-8 hr |
|---|---|---|---|---|
| type | emulsifier/MDI/HDI trimer | (mPa*s) | (nm) | (%) |
| PMDI | 40/0/60 | 5610 | 216 | nt |
| PMDI | 40/10/50 | 8640 | 201 | 90 |
| PMDI | 40/30/30 | 7580 | 163 | 70 |
| PMDI | 40/50/10 | 4740 | 155 | 56⁽³⁾ |
| monomer | 40/0/60 | 5610 | 216 | nt |
| monomer | 40/10/50 | 3450 | 140 | 81 |
| monomer | 40/30/30 | 1230 | 135 | 58 |
| monomer | 40/50/10 | 510 | 137 | 51 |

Note⁽³⁾:
measured at 7.5 hours.

All the samples with MDI monomer or PMDI showed acceptable viscosity, particle size, and remaining NCO content.

1. A composition comprising
(a1) one or more compound that is a trimer of a diisocyanate that has structure I-1:
A1-NCO I-1
(b1) one or more compound having the structure II-1:
A1-L1-(CH₂CH₂O)ₙ—Z II-1
(a2) one or more compound that is a trimer of a diisocyanate that has structure I-2:
A2-NCO I-2
and
(b2) one or more compound having the structure II-2:
A2-L2-Q-G II-2
wherein
A1 in structure II-1 is identical to A1 in structure I-1,
L1 is a linking group formed by a reaction of an isocyanate group with an isocyanate-reactive group,
n is 5 to 25,
Z is an alkyl group,
A2 in structure II-2 is identical to A2 in structure I-2,
L2 is a linking group formed by a reaction of an isocyanate group with an isocyanate-reactive group,
Q is an organic group, and
G is an anionic group,
A1 and A2 may be identical or different,
wherein
wa1+wa2 is 0% to 90%,
wherein wa1 is the weight percent of said compound (a1), based on the total solids weight of said composition,
wherein wa2 is the weight percent of said compound (a2), based on the total solids weight of said composition,
wherein
wb1+wb2 is 10% to 100%,
wherein wb1 is the weight percent of said compound (b1), based on the total solids weight of said composition,
wherein wb2 is the weight percent of said compound (b2), based on the total solids weight of said composition,
and wherein the ratio wb1:wb2 is between 0.01:1 and 100:1.

2. The composition of claim 1 wherein A1 is a residue of a trimer of hexane diisocyanate and wherein A2 is a residue of a trimer of hexane diisocyanate.

3. The composition of claim 1 wherein n is 10 to 14.

4. The composition of claim 1 wherein G is a sulfonate group.

5. An emulsion comprising particles suspended in an aqueous medium, wherein said particles comprise
(a1) one or more compound that is a trimer of a diisocyanate that has structure I-1:
A1-NCO I-1
(b1) one or more compound having the structure II-1:
A1-L1-(CH₂CH₂O)ₙ—Z II-1
(a2) one or more compound that is a trimer of a diisocyanate that has structure I-2:
A2-NCO I-2
(b2) one or more compound having the structure II-2:
A2-L2-Q-G II-2
and
(c) one or more water-insoluble compound that is different from said trimer (a), wherein
A1 in structure II-1 is identical to A1 in structure I-1,
L1 is a linking group formed by a reaction of an isocyanate group with an isocyanate-reactive group,
n is 5 to 25,
Z is an alkyl group,
A2 in structure II-2 is identical to A2 in structure I-2,
L2 is a linking group formed by a reaction of an isocyanate group with an isocyanate-reactive group,
Q is an organic group, and
G is an anionic group,
A1 and A2 may be identical or different,
wherein
wa1+wa2 is 0% to 90%,
wherein wa1 is the weight percent of said compound (a1), based on the total solids weight of said emulsion,
wherein wa2 is the weight percent of said compound (a2), based on the total solids weight of said emulsion,
wherein
wb1+wb2 is 10% to 100%,
wherein wb1 is the weight percent of said compound (b1), based on the total solids weight of said emulsion,
wherein wb2 is the weight percent of said compound (b2), based on the total solids weight of said emulsion,
and wherein the ratio wb1:wb2 is between 0.01:1 and 100:1.

6. The emulsion of claim 5 wherein said water-insoluble compound (c) is a polyisocyanate.

7. The emulsion of claim 5 wherein said water-insoluble compound (c) is an aromatic polyisocyanate.
